(19) United States
(12) Patent Application Publication
(10) Pub. No.: US 2026/0266763 A1
(43) Pub. Date: Sep. 10, 2026

(54) Method and System for Introducing Modifier into a Curtain Gas Stream for a Differential Mobility Spectrometer

(71) Applicant: DH Technologies Development Pte. Ltd., Singapore (SG)

(72) Inventors: Samad BAZARGAN, Brampton (CA); John J. CORR, Richmond Hill (CA)

(73) Assignee: DH Technologies Development Pte. Ltd., Singapore (SG)

(21) Appl. No.: 19/166,706

(22) PCT Filed: Mar. 21, 2024
(86) PCT No.: PCT/IB2024/052723

§ 371 Date: Sep. 18, 2025

Related U.S. Application Data
(60) Provisional application No. 63/454,131, filed on Mar. 23, 2023.

(51) Int. Cl. G01N 27/623; H01J 49/16

(52) U.S. Cl. CPC G01N 27/623; H01J 49/167

(57) ABSTRACT

In one aspect, a mass spectrometer system includes an ion mobility spectrometer (IMS), a gas supply for providing a curtain gas, a modifier supply for providing a liquid modifier, and a nebulizer for receiving the liquid modifier from the modifier supply and generating liquid droplets for delivery to a curtain chamber of the IMS. The spectrometer includes a fluid manifold for receiving the liquid modifier and delivering the liquid modifier to the nebulizer and to receive the curtain gas from the gas supply and provide a first portion of the curtain gas to the nebulizer as a nebulizing gas and provide a second portion of the curtain gas as a sheath flow to a region in vicinity of a nozzle of the nebulizer such that a combination of the sheath flow and gas exiting the nebulizer flows as a curtain gas entraining the liquid droplets to the curtain chamber.

### RELATED APPLICATIONS

This application claims priority to U.S. Provisional Application No. 63/454,131 filed on Mar. 23, 2023, the contents of which are incorporated herein in their entirety.

### TECHNICAL FIELD

The present disclosure is directed generally to mass spectrometry and more particularly to systems and methods for delivering liquid modifiers to ion mobility spectrometers utilized in mass spectrometry systems.

### BACKGROUND

Mass spectrometry (MS) is an analytical technique for determining the elemental composition of a substance. Specifically, MS measures a mass-to-charge ratio (m/z) of ions generated from a test substance. MS can be used to identify unknown compounds, to determine isotopic composition of elements in a molecule, to determine the structure of a particular compound by observing its fragmentation, and to quantify the amount of a particular compound in a sample. Mass spectrometers detect ions and as such, a test sample must be converted to an ionic form during mass analysis.

In some mass spectrometry systems, an ion mobility spectrometer (IMS) is employed upstream of a mass spectrometer to separate ions based on their mobility, e.g., to facilitate detection of isobaric/isomeric compounds. By way of example, in a differential mobility spectrometer (DMS), a drift gas is typically supplied from a gas source to a curtain chamber of the DMS/MS system. The drift gas can provide a gas flow through the DMS to facilitate introduction of ions generated by an upstream ion source into the DMS. A modifier liquid can be added, in the form of a vapor, to the drift gas to provide, for example, selectivity by clustering with ions to different degrees, thereby shifting the differential mobility of the ions, and hence facilitating their separation.

### SUMMARY

In one aspect, a mass spectrometer is disclosed, which comprises an ion mobility spectrometer (IMS) for receiving ions from an ion source, a gas supply for providing a gas, a modifier supply for providing a liquid modifier, and a nebulizer for receiving the liquid modifier from the modifier supply and generating liquid droplets for delivery to a curtain chamber of the IMS. The mass spectrometer further comprises a gas distribution system comprising a first gas-delivery conduit in fluid communication with the gas supply and configured to deliver at least a portion of the gas supplied by the gas supply to a region in vicinity of a nozzle of said nebulizer as a sheath flow gas and a second gas-delivery conduit in fluid communication with the gas supply and with the nebulizer for delivery of at least a portion of the gas supplied by the gas supply to the nebulizer such that a combination of gas exiting the nebulizer's nozzle and the sheath flow gas flows as a curtain gas entraining the liquid droplets to the curtain chamber of the IMS.

In some embodiments, the mass spectrometer can further include at least one controller that is in fluid communication with the gas supply and with at least one of said gas-delivery conduits for adjusting a flow rate of the gas supplied to that gas-delivery conduit. In some such embodiments, the controller can include two independent controllers, where one of those controllers is in fluid communication with the gas supply and with the first gas-delivery conduit for adjusting a flow rate of the sheath flow gas and the other controller is in fluid communication with the gas supply and with the second gas-delivery conduit for adjusting a flow rate of the gas delivered to the nebulizer.

In some embodiments, the gas distribution system includes a fluid manifold that provides the first and the second gas-delivery conduits such that one of the first and the second gas-delivery conduits is in fluid communication with the gas supply via the other gas-delivery conduit.

In some embodiments, the first conduit of the gas distribution system can include an inlet for receiving the gas from the gas supply and delivering a first portion of the received gas as the sheath flow gas to the vicinity of the nebulizer's nozzle and the second gas conduit can include an inlet in fluid communication with the first gas conduit for receiving a second portion of the gas received by the first conduit and deliver said second portion of the gas via an outlet thereof as the nebulizer gas to the nebulizer.

The nebulizer can further include an electrode positioned in a gas-delivery channel of the nebulizer, where the electrode extends from a proximal end that is configured to receive the liquid modifier, through an aperture, to a distal end that is positioned external to the nebulizer's channel. In various embodiments, the electrode can have an inner diameter in a range of about 50 micrometers to about 500 micrometers, e.g., in a range of about 100 micrometers to about 150 micrometers, by way of example.

In some embodiments, an aperture of the nebulizer's nozzle can have an internal diameter in a range of about 100 micrometers to about 2 mm. Further, in some embodiments, the distal end of the electrode protrudes through the nozzle's aperture by a distance in a range of about 100 micrometers to about 4 mm.

In a related aspect, a mass spectrometry system is disclosed, which includes an ion mobility spectrometer (IMS) for receiving ions from an ion source, a gas supply for providing a gas, a modifier supply for providing a liquid modifier, and a nebulizer for receiving the liquid modifier from the modifier supply and generating liquid droplets for delivery to a curtain chamber of the system. The mass spectrometry system can further include a fluid manifold configured to receive the liquid modifier from the modifier supply and deliver the liquid modifier to a nebulizer. The fluid manifold is further configured to receive the gas from the gas supply and provide a first portion of the gas to a region in vicinity of a nozzle of the nebulizer as a sheath flow gas and a second portion of the gas to the nebulizer as a nebulizing gas (herein also referred to as a nebulizer gas) such that a combination of the sheath flow gas and the gas exiting the nebulizer flows as a curtain gas entraining the liquid droplets to the curtain chamber of the IMS or DMS.

The nebulizer can include an electrode extending from a proximal end providing an inlet for receiving the liquid modifier to a distal end providing an outlet through which the liquid modifier can exit the electrode such that liquid droplets are formed in vicinity of the nozzle. In some embodiments, the distal end of the electrode can protrude through the aperture of the nebulizer's nozzle such that a portion of the electrode is positioned external to the nebulizer.

Further, in some embodiments, the aperture of the nebulizer's nozzle can have an internal diameter in a range of about 100 micrometers to about 2 mm.

In some embodiments, the nebulizer's electrode can have an inner diameter in a range of about 50 micrometers to about 500 micrometers, e.g., in a range of about 100 micrometers to about 400 micrometers, or in a range of about 200 micrometers to about 300 micrometers., e.g., 50 micrometers to 150 micrometers. In some such embodiments, the length of a portion of the electrode that protrudes out of the nebulizer's nozzle can be in a range of about 100 micrometers to about 4 mm, e.g., in a range of about 200 micrometers to about 1 mm, or in a range of about 300 micrometers to about 500 micrometers.

In some embodiments, the nebulizer is employed without application of a voltage to the electrode. In other embodiments, the nebulizer's electrode can be configured for application of a DC voltage thereto. By way of example, the mass spectrometer can include a DC voltage supply for application of a DC voltage to the electrode. By way of example, the DC voltage supply can apply a DC voltage in a range of about ±100 volts to about ±7000 volts to the nebulizer's electrode. In some embodiments, the application of the DC voltage to the nebulizer's electrode can be used to generate an electric field in the vicinity of the nebulizer's nozzle to facilitate the formation of liquid droplets, e.g., to facilitate the breakup of liquid droplets into smaller droplets. Further, in some embodiments, an electric field generated in the vicinity of the nebulizer's nozzle, via application of a DC voltage to the nebulizer's electrode, can cause ionization of at least a portion of the liquid modifier exiting the nebulizer. By way of example, the use of the same voltage polarity as the sprayer on the transfer tubing can help keep the charged droplets from impinging on the walls, which will facilitate evaporation. Further, in some cases, the application of a DC voltage to the nebulizer's electrode may facilitate the separation of isobaric species via interaction with the neutral and charged ion species in the source region.

In some embodiments, the fluid manifold can include a liquid conduit having an inlet that is in fluid communication with the modifier supply for receiving the liquid modifier and having an outlet that is in fluid communication with the inlet of the nebulizer for delivering the liquid modifier to the nebulizer. In some such embodiments, an isolation valve that is operably coupled to the liquid conduit of the fluid manifold can regulate the flow of the liquid modifier through the liquid conduit.

The fluid manifold can include a first gas conduit having an inlet for receiving the gas from the gas supply and an outlet through which a first portion of the received gas exits the first gas conduit as a sheath flow gas. The fluid manifold can also include a second gas conduit in fluid communication with the first gas conduit at a fluid junction so as to receive a second portion of the gas, where the second gas conduit includes an outlet in fluid communication with the nebulizer's channel for delivering the second portion of the gas to the nebulizer as the nebulizing gas.

A flow restrictor can be positioned in the first gas conduit for adjusting the flow rate of the first portion of the gas provided as the sheath flow gas to the region in the vicinity of the nebulizer's nozzle so as to help direct the liquid droplets to the curtain chamber. Further, the flow restrictor can generate a sufficient back pressure within the first gas conduit, which causes a portion of the curtain gas received by the first gas conduit to flow into the second gas conduit. In some embodiments, the flow restrictor can be configured to allow a flow rate in a range of about 0 to about 30 slpm as the first portion of the gas delivered to the vicinity of the nebulizer's nozzle as the sheath flow gas. In some such embodiments, the flow rate of the second portion of the gas, i.e., the gas flow through the nebulizer, can be in a range of about 0.1 to about 20 slpm.

In some embodiments, the flow restrictor can be implemented as a disk having an aperture that has a size less than an inner diameter of the gas conduit in which it is positioned. In some embodiments, the flow restrictor has an adjustable aperture whose size can be varied to achieve different flow rates of the first gas portion and consequently provide different back pressures associated with those flow rates.

The flow restrictor and the size of an opening of the nebulizer's nozzle can be configured to provide a desired flow rate of the second portion of the gas through the nebulizer. In general, the flow rates of the first and the second portions of the gas are selected so as to facilitate the generation of liquid droplets via the nebulizer and also to provide a sufficient flow of the curtain gas to the curtain chamber.

In some embodiments, the flow restriction of the gas flowing through the first conduit can be achieved via tapering the first gas conduit to have a decreasing cross-sectional area, e.g., in a region in vicinity of the distal end of the conduit. By way of example, in some such embodiments, the conduit may include a distal portion exhibiting a continuous taper that provides a progressively smaller cross-sectional area along a direction extending from the conduit's proximal end toward its distal end.

In a related aspect, a method for supplying a gas flow to a curtain chamber of an ion mobility spectrometer (IMS) is disclosed, which comprises generating two gas flow streams, delivering one of the gas flow streams to a nebulizer as a nebulizer gas to flow through a channel of the nebulizer and exit the nebulizer via a nozzle thereof, wherein the nebulizer receives a liquid modifier from a modifier supply and generates a plurality of droplets of the liquid modifier, and delivering the other one of the gas flow streams to a region in vicinity of the nebulizer's nozzle as a sheath flow gas such that a combination of the nebulizer gas exiting the nebulizer and the sheath flow gas forms a curtain gas entraining the liquid droplets, thereby generating a liquid-gas mixture (e.g., an aerosol mixture). The liquid-gas mixture is supplied to the curtain chamber of the IMS.

In various embodiments, the nebulizer (or at least the nebulizer's nozzle) is positioned within a conduit and the sheath flow gas is introduced into the conduit in the vicinity of the nebulizer's nozzle. By way of example, and without limitation, the nebulizer gas may be delivered to the nebulizer at a flow rate in a range of about 0.1 to about 20 slpm. Further, in some such embodiments, the sheath flow gas may be delivered to the conduit in which the nebulizer is positioned at a flow rate in a range of about 0 to about 30 slpm.

In some embodiments, the two gas flow streams are generated by splitting a gas supplied by a single gas source into the two streams. At least one controller can be utilized to control the flow rate of the gas in at least one of the two gas flow streams. In some cases, the flow rate in each gas flow stream can be controlled independently of the flow rate in the other gas flow stream, e.g., by employing two independent controllers.

Further understanding of various aspects of the present teachings can be obtained by reference to the following detailed description in conjunction with the associated drawings, which are described briefly below.

### BRIEF DESCRIPTION OF THE DRAWINGS

FIG. 1A schematically depicts a differential mobility spectrometer coupled to a conventional system for delivering a curtain gas and a liquid modifier entrained in the curtain gas to a curtain chamber thereof,

FIG. 1B schematically depicts a mass spectrometry system according to an embodiment of the present teachings,

FIG. 1C schematically depicts a flow restrictor suitable for use in various embodiments of a mass spectrometry system according to the present teachings,

FIG. 1D schematically depicts an embodiment in which a damper is utilized to counter fluctuations in the flow rate of the liquid modifier that may result from pulsation of a pump employed to deliver the liquid modifier to a nebulizer employed to generate liquid droplets,

FIG. 1E schematically depicts a conduit having a tapered section that can be utilized as a flow restrictor,

FIG. 2A schematically depicts a mass spectrometer according to another embodiment of the present teachings,

FIGS. 2B, 2C, 2D, and 2E schematically depict examples of flow restrictors that can be placed in the gas-delivery channel of the nebulizer for adjusting the velocity and the flow rate of the nebulizing gas;

FIG. 3A shows the normalized intensity of Safranin Orange ions as a function of compensation voltage applied to the electrodes of a DMS using two different concentrations of Acetonitrile as the liquid modifier and using a conventional system for delivering the liquid modifier to a curtain chamber of the DMS,

FIG. 3B shows the normalized intensity of Safranin Orange ions as a function of the compensation voltage applied to the electrodes of the DMS using several concentrations of Acetonitrile as the liquid modifier and using an embodiment of a system according to the present teachings for delivery of the liquid modifier to the curtain chamber of the DMS,

FIG. 4A shows normalized ion intensity data obtained for Morphine ions as a function of the compensation voltage applied to the DMS using a conventional system for delivery of Acetonitrile as a liquid modifier at two concentrations to a curtain chamber of the DMS,

FIG. 4B shows normalized ion intensity data obtained for Morphine ions as a function of the compensation voltage applied to the DMS using an embodiment of a system according to the present teachings for delivery of Acetonitrile as a liquid modifier to the curtain chamber of the DMS at several different concentrations,

FIG. 5A shows normalized ion intensity data obtained for Haloperidol ions as a function of the compensation voltage applied to the DMS using a conventional system for delivery of Acetonitrile as a liquid modifier to the curtain chamber of the DMS at two different concentrations,

FIG. 5B shows normalized ion intensity data obtained for Haloperidol ions as a function of the compensation voltage applied to the DMS using an embodiment of a system according to the present teachings for delivery of Acetonitrile as a liquid modifier to the curtain chamber of the DMS at several concentrations,

FIG. 6A shows normalized ion intensity data associated with compounds in a sample containing 140 compounds of different chemical categories covering the m/z range of 90 to 1200 in a 50:50 v/v % of Water: Methanol as a function of compensation voltage applied to a DMS of a mass spectrometer, where the data was acquired without the use of a liquid modifier,

FIGS. 6B, 6C, 6D, and 6E show normalized ion intensity data associated with the same compounds as those utilized for acquisition of the data depicted in FIG. 6A, but with the use of isopropyl alcohol (IPA) as a liquid modifier delivered at different concentrations to the DMS of the mass spectrometer using a delivery system according to an embodiment of the present teachings,

FIGS. 7A, 7B, 7C, 7D, and 7E show normalized ion intensity data associated with the same compounds as those in FIG. 6A as a function of the compensation voltage, where the data was obtained, respectively, without a liquid modifier (FIG. 7A) and with Ethyl Acetate as a liquid modifier delivered at different concentrations to the DMS via a delivery system according to an embodiment of the present teachings (7B-7E), and

FIGS. 8A, 8B, 8C, and 8D show normalized ion intensity data associated with the same compounds as those in FIG. 6A as a function of the compensation voltage, where the data was obtained, respectively, without a liquid modifier (FIG. 8A) and with Acetonitrile as a liquid modifier delivered at different concentrations to the DMS via a delivery system according to an embodiment of the present teachings (FIGS. 8B-8D).

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

The term “ion mobility spectrometer” and its abbreviation “IMS” are employed herein to refer to a device that is capable of separating ions based on their mobility or their mobility difference in a high field asymmetric waveform.

The phrase “in vicinity of the nozzle,” as used herein, refers generally to a region external to a nebulizer's nozzle in which liquid droplets are formed. By way of example, and without limitation, such a region can be within a distance of about 0.1 mm to about 20 mm, e.g., in a range of about 1 mm to about 5 mm from the nebulizer's nozzle.

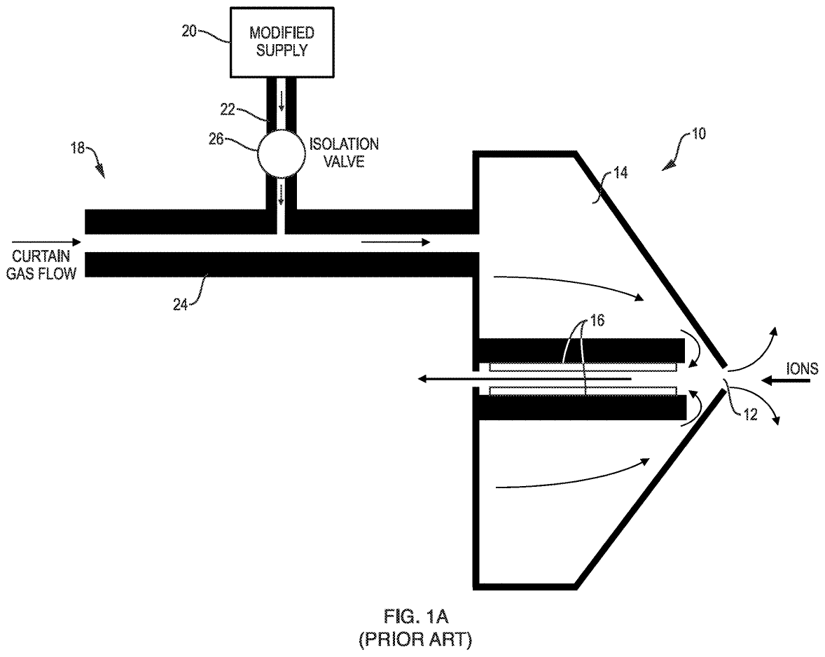

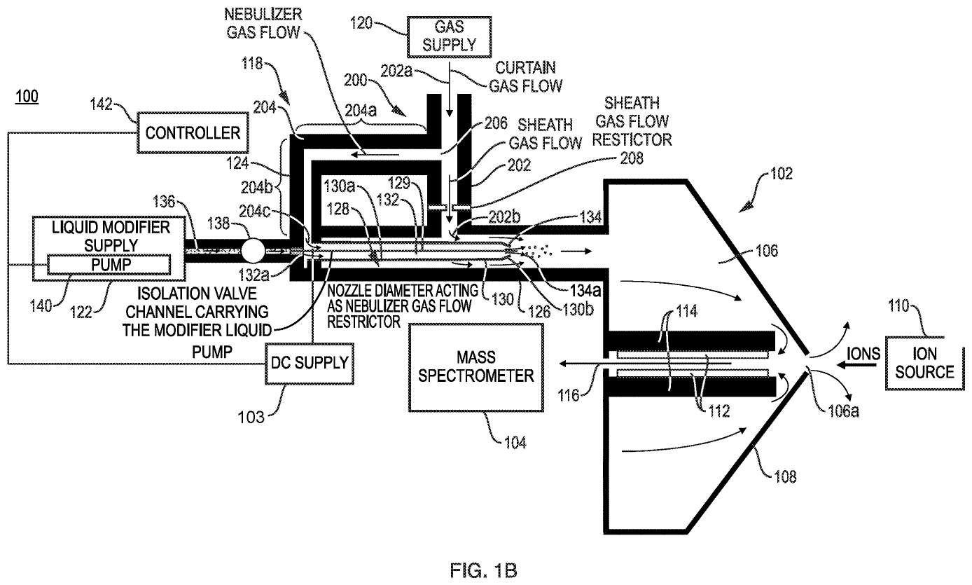

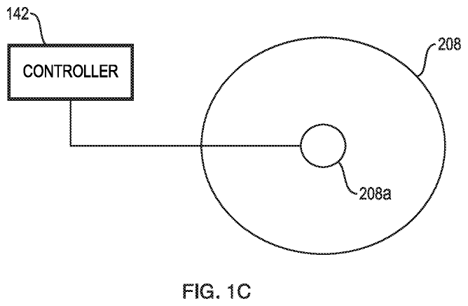

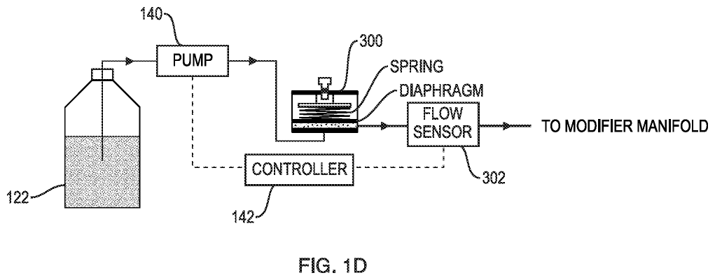

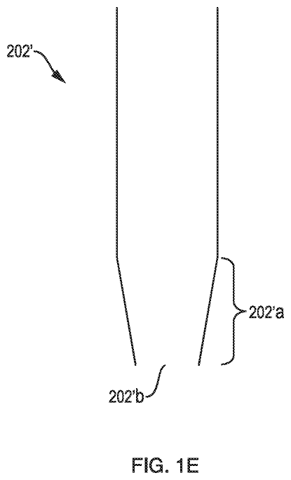

FIG. 1A schematically depicts a differential mobility spectrometer (DMS) system 10 including a curtain chamber 14 with an inlet 12 for receiving ions from an ion source (not shown), a pair of electrodes 16 disposed in the curtain chamber to which a time-dependent voltage can be applied for causing separation of ions based on their mobility difference between high and low fields. FIG. 1A further depicts a conventional system 18 for delivering a curtain gas in which a liquid modifier is entrained to the curtain chamber of the DMS 10. The system 18 includes a modifier supply 20 that provides a liquid modifier, which can be transported through a liquid conduit 22 to a gas conduit 24 that is fluidically coupled at a T-junction to the liquid conduit 22. An isolation valve 26 can regulate the flow of the liquid modifier through the liquid conduit 22. The gas flowing through the gas conduit 24 entrains the liquid modifier and transports the liquid modifier to the curtain chamber 14.

One shortcoming of such a prior art system is that it introduces inhomogeneity in the gas composition particularly at low concentrations of the liquid modifier, e.g., due to a large internal diameter of the liquid conduit leading to the T-junction. For example, depending on the surface tension and evaporation rate of the liquid modifier as well as the velocity of the curtain gas, the liquid introduced into the T-junction may form liquid droplets that can travel along the wall of the gas conduit until they are evaporated, leading to inhomogeneity in the gas composition and consequently fluctuations in the observed analytical signals.

As discussed in more detail below, various embodiments of the present teachings provide improved systems and methods for delivery of a curtain gas in which a liquid modifier is entrained to an ion mobility separation system. Without any loss of generality and for illustrative purposes, the following description of various aspects of the present teachings is provided with reference to a differential mobility mass spectrometer/mass spectrometer system. It should, however, be understood that the present teachings are equally applicable for delivery of a curtain gas in which a liquid modifier is entrained to other ion mobility separation devices. Some examples of such ion mobility separation devices include, without limitation, differential mobility spectrometer (DMS) e.g., a field asymmetric waveform ion mobility spectrometer (FAIMS), a drift tube, travelling wave IMS, TIMS, or Differential Mobility Analyzer (DMA).

Further, by way of example, the DMS can include planar devices, cylindrical FAIMS, spherical FAIMS, or micromachined devices.

FIG. 1B schematically depicts a mass spectrometer system 100 according to an embodiment that includes a differential mobility spectrometer (DMS) 102 and a mass spectrometer 104 positioned downstream of the differential mobility spectrometer 102. By way of example and without limitation, in some embodiments, the mass spectrometer 104 can be a triple quadrupole mass spectrometer, a hybrid quadrupole/time-of-flight (ToF) mass spectrometer, or any other mass spectrometry system which includes one or more mass analyzers in a vacuum chamber.

The DMS 102 includes a curtain chamber 106 that is defined by a curtain plate or boundary member 108. The curtain chamber 106 includes an inlet 106a through which ions generated by an upstream ion source 110 can be introduced into the DMS. A pair of electrically conductive electrodes 112, in the form of plates, are disposed within the curtain chamber and provide a passageway therebetween through which the ions received by the DMS 102 can transit. An electrical insulator 114 is disposed along the outer surfaces of the electrodes 112 to support the electrodes and isolate them from other conductive elements in the DMS, and also to provide a gas shield and limit the gas flow entering the passageway between the electrodes to be only through the proximal end facing the incoming ions from the upstream source and through the curtain chamber inlet of 106a. By way of example, and without limitation, the insulator may be fabricated from ceramic, TeflonTM, or other insulators such as PEEK.

As discussed in more detail below, a drift gas can be introduced into the space between the two electrodes at a proximal end of the electrode pair and can flow through the space between the two electrodes and exit the space between the two electrodes at a distal end of the electrodes. The drift gas and ions entrained in the drift gas are released via an outlet of the DMS and may be transported through an inlet orifice 116 or tube to enter the mass spectrometer. In some embodiments an additional chamber may be included between the DMS and inlet 116 for other purposes such as controlling the gas flow rate through the DMS electrodes 112, as described in U.S. Pat. No. 9,171,711, which is herein incorporated by reference in its entirety.

The mass spectrometer system 100 further includes a fluid manifold 118 that provides a fluid interface between a gas supply 120, which supplies a curtain gas, and a modifier supply source 122, which supplies a liquid modifier, to the curtain chamber of the DMS.

The fluid manifold 118 includes a frame 124 that supports a plurality of conduits.

More specifically, in this embodiment, the frame 124 includes a conduit 126 in a portion of which a nebulizer 128 is positioned. The nebulizer 128 includes a housing 130 that circumscribes a channel 132 that extends from a proximal end (at inlet 132a) to a distal end providing a nozzle 134 having an aperture 134a. More specifically, in this embodiment, the nebulizer housing 130 includes a substantially cylindrical portion 130a that extends to a distal tapered portion 130b, which forms the nozzle 134. The nebulizer 128 further includes an electrode 129 positioned in the channel 132 so as to receive the liquid modifier and facilitate the formation of liquid droplets.

The frame 124 of the fluid manifold 118 further includes a fluid conduit 136 that fluidically connects the modifier supply source 122 to the inlet 132a of the nebulizer to deliver the liquid modifier to the nebulizer's electrode. An isolation valve 138 can be utilized to isolate the source of the liquid modifier from the nebulizer and regulate the flow of the liquid modifier into the nebulizer.

In this embodiment, the modifier supply source 122 includes a pump 140 operating under control of a controller 142 that pumps the liquid modifier into the nebulizer. The controller 142 can transmit control signals to the pump 140 to adjust the rate at which the liquid modifier is supplied to the nebulizer.

The frame 124 further includes a gas manifold 200 that receives a gas from the gas supply 120 and splits the received gas into two portions, where one portion is delivered to the nebulizer 128 to function as a nebulizing gas and another portion is delivered as a sheath flow gas to a region in vicinity of the nebulizer's aperture 134a to entrain the liquid droplets and transport the liquid droplets to the curtain chamber of the DMS as discussed in more detail below.

More specifically, in this embodiment, the gas manifold 200 includes a first gas conduit 202 having an inlet 202a that is in fluid communication with the gas supply 120 to receive a flow of gas therefrom. The first gas conduit 202 further includes an outlet 202b through which a portion of the received gas exits the conduit to function as a sheath flow gas for facilitating the transport of liquid droplets generated by the nebulizer to the curtain chamber of the DMS, as discussed in more detail below.

In this embodiment, the gas manifold 200 further includes a second gas conduit 204 that branches from the first gas conduit and is in fluid communication with the first gas conduit 202 at a fluid junction 206 so as to receive a portion of the gas introduced into the first gas conduit from the gas supply 120. The second gas conduit 204 includes two gas channels 204a and 204b, where a portion of the gas received by the first conduit is directed to the gas channel 204a and is delivered through the gas channel 204b via an outlet 204c of the second gas conduit 204 to the nebulizer 128 as a nebulizing gas. Although in this embodiment the two gas channels 204a and 204b are shown as being orthogonal to one another, in other embodiments they can form other angles relative to one another.

The nebulizing gas exiting the nebulizer's nozzle with a high velocity at proximity of the tip of the internal channel of the nebulizer carrying the liquid modifier breaks up the liquid into a plurality of liquid droplets and forces them away from the nozzle's aperture into a region external to the nebulizer thereby forming an aerosol mixture.

With continued reference to FIG. 1B, in this embodiment, the nebulizer 128 extends beyond the outlet 202b of the first gas conduit 202 such that the nebulizer's nozzle is positioned distal to the outlet of the gas conduit 202. The first portion of the gas received by the gas manifold that exits the first gas conduit 202 flows in an annular space between the outer surface of the portion of the nebulizer extending past the outlet of the first gas conduit 202 and an inner surface of the conduit 126 as a sheath flow gas.

The combination of the gas exiting the nebulizer and the sheath flow gas associated with the gas exiting the first gas conduit 202 can entrain the liquid droplets and provide a drift gas flow for delivery as a curtain gas to the curtain chamber of the DMS, where the drift gas flow carries the liquid droplets to the curtain chamber 106.

With continued reference to FIG. 1B as well as reference to FIG. 1C, in this embodiment, a flow restrictor 208 is positioned in the flow path of the gas flowing through the first gas conduit 202 to adjust the flow rate of the gas exiting the gas conduit 202 as the sheath flow gas.

In this embodiment, the flow restrictor 208 is in the form of a disk in which an opening 208a (herein also referred to as aperture 208a) for passage of the gas is provided. The diameter of the opening 208a is less than the internal diameter of the conduit 202 so as to cause a flow restriction of the gas flowing through that conduit. By way of example, and without limitation, a ratio of the diameter of the opening 208a to the internal diameter of the conduit 202 can be in a range of about 1 to about 0.01.

As noted above, in some embodiments, the flow restrictor is configured, e.g., via selection of an appropriate size for the opening 208a of the flow restrictor 208, to provide the sheath flow gas at a flow rate in a range of about 0 to about 30 slpm to the conduit 126 in a region in the vicinity of the nebulizer's nozzle. In other embodiments, the flow restrictor 208 may include an aperture 208a with an adjustable diameter for varying or optimizing the flow restriction.

The flow restrictor 208 can also generate a gas back pressure within the first gas conduit 202, which causes a second portion of the gas to flow to the nebulizer 128 via forcing a portion of the gas received by the conduit 202 to be transferred to the second gas conduit 204 and be delivered, via the outlet 204c of the second gas conduit 204 to the nebulizer 128. The back pressure provided by the flow restrictor 208 and the size of the nozzle's aperture as well as the outer diameter of the electrode 129 can cooperatively define the flow rate of the gas through the nebulizer's channel.

The inner diameter of the aperture of the nebulizer's nozzle can be optimized, e.g., based on the desired flow range, the available back pressure provided by the liquid modifier pump, the gas back pressure provided by the flow restrictor, and the viscosity of the liquid modifier of interest. For example, as the viscosity of the liquid modifier increases, a greater back pressure provided by the liquid modifier pump for achieving a desired flow rate may be needed. In various embodiments, the back pressure supplied by the liquid modifier pump can be, for example, in a range of about 10 to about 500 psig. By way of illustration, and without limitation, the diameter of the nozzle's aperture can be in a range of about 100 micrometers to about 2 mm. Further, in some embodiments, the inner diameter of the nebulizer's electrode can be in a range of about 50 micrometers to about 150 micrometers.

Referring again to FIG. 1C, in some embodiments, the size of the aperture 208a of the flow restrictor 208 can be adjustable to allow configuring the flow restrictor to provide a plurality of different flow restrictions, and hence different gas flow rates to the conduit 126. In some such embodiments, the aperture's size can be continuously adjusted between a minimum and a maximum aperture size while in other embodiments, the adjustment of the aperture's size can be done in discrete steps. By way of example, in some cases, the adjustment of the size of the aperture 208a can be achieved by utilizing a set of orifices having different sizes or by employing an iris aperture. The adjustment of the aperture size can be achieved under control of a controller. For example, the controller 142 can be programmed in a manner known in the art and as informed by the present teachings to provide a desired adjustment of the aperture 208a, either as a continuous adjustment or as a series of discrete adjustments.

Generally, the curtain gas and modifier liquid flow rates are user defined parameters and in addition to these gas flows, a resolution gas flow may also be added to the DMS to increase the residence time of the ions in the DMS and improve the resolution. When this resolution gas is added, curtain gas flow is reduced by the amount of this resolution gas flow. If a very high-resolution gas flow is used, a drastic drop in curtain gas flow will be required and in this case the sheath flow restriction needs to be adjusted so as to divert more of the flow to the nebulizer to make sure an effective nebulization still occurs. In various embodiments, to accommodate these changes and the different curtain gas and modifier flow rates that may be desired, the sheath flow restriction can be adjusted.

With particular reference to FIG. 1B, in various embodiments, the sheath flow gas provided by the gas exiting the conduit 202 can advantageously keep the liquid droplets away from the inner surface of the conduit 126 to prevent condensation of the liquid droplets on that surface, particularly at low flow rates, which further facilitates liquid modifier aerosol evaporation.

With reference to FIG. 1D, in some embodiments, the back pressure applied to the liquid modifier to cause its flow through the liquid conduit 126 may exhibit pulsations, e.g., due to pulsation that is inherent to various reciprocating displacement and rotary-based pumps 140. In this embodiment, a damper 300 is utilized to regulate such pressure pulsations (herein also referred to as pressure fluctuations) so as to provide a steady back pressure for causing a steady transfer of the liquid modifier to the nebulizer. By way of example, the use of the damper 300 can eliminate short term oscillations of flow from the pump to provide a more uniform modifier concentration in the gas. In this example, a sensor 302 can measure the flow rate of the liquid modifier delivered by the liquid modifier source and the controller 142 can receive the measured flow rate and control the pump 140 so as to deliver the liquid modifier to the nebulizer at a desired flow rate.

As noted above, in some embodiments, the flow restriction in the gas conduit 202 can be implemented via tapering the gas conduit 202. By way of example, and without limitation, FIG. 1E schematically depicts such an implementation of the gas conduit 202, herein labeled as the gas conduit 202′, which has a tapered distal portion 202′a exhibiting a progressively decreasing cross-sectional area towards the outlet 202′b of the gas conduit. By way of example, and without limitation, in some embodiments, a ratio of the maximum to the minimum cross-sectional area of the gas conduit 202′ can be in a range of about 1 to about 100.

Referring again to FIG. 1B, in some embodiments, the pressure of the curtain gas in the curtain chamber 106 can be maintained at or near atmospheric pressure, i.e., about 760 Torr, e.g., via adjustment of the flow rate of the curtain gas into the conduit 202. Such a pressure of the curtain gas within the curtain chamber of the DMS can provide both a curtain gas inflow into the DMS as well as a curtain gas outflow out of the inlet 106a of the curtain gas chamber. The inflow of the curtain gas functions as a drift gas that carries ions received via the inlet of the curtain chamber through the space between the electrode pairs 112 into the downstream mass spectrometer 104.

The mass spectrometer 104 can be any suitable mass spectrometer that can provide mass analysis of the ions based on differences in their m/z ratios. By way of example, the mass spectrometer 104 can be any of a quadrupole mass spectrometer, a triple quadrupole mass spectrometer, a time-of-flight mass spectrometer, or any other MS system that includes one or more mass analyzers in a vacuum enclosure. Alternatively, rather than a mass spectrometer, a detector may be positioned downstream of the outlet of the differential mobility spectrometer 102 such as a Faraday cup or other ion current measuring device.

With continued reference to FIG. 1B, in some implementations, the mass spectrometer system 100 can include a DC voltage supply 103 that operates under the control of the controller 142 (or another controller) and is electrically coupled to the electrode 129 of the nebulizer to apply a DC voltage thereto. By way of example, the DC voltage supply 103 can apply a voltage in a range of about ±100 to about ±7000 volts to the electrode 129. In some embodiments, the voltage applied to the electrode 129 can be selected such that the resultant electric field will facilitate the breakup of the liquid droplets into smaller ones without causing the ionization of the liquid modifier. For example, in some such embodiments, the voltage applied to the electrode 129 can be in a range of about ±10 to about ±1000 volts. In other embodiments, the voltage applied to the electrode 129 can be selected such that the resultant electric field will cause ionization of at least a portion of the liquid modifier in the droplets. For example, in some such embodiments, the voltage applied to the electrode 129 can be in a range of about ±1000 to about ±5000 volts. It will be understood by those of skilled in the relevant arts that charged modifiers may interact with ions with different mechanisms than the typical clustering behavior of a neutral modifier and charged species. For instance, modifiers that are negatively charged may interact in a stronger or less specific manner with positively charged ions. Modifiers and ions of the same polarity may repel each other. Therefore, it may be beneficial to provide an extra neutralization step for modifiers or droplets prior to interaction with charged analytes.

In various embodiments, the systems and methods according to the present teachings for introducing a liquid modifier to the curtain chamber of an IMS provide certain advantages. For example, they can enable the use of a larger concentration range of liquid modifiers compared to conventional techniques, thereby providing additional control in the use of modifiers for separating compounds. For example, when utilizing a DMS for separating compounds based on their mobility, the ability to use a larger concentration range for the liquid modifier can lead to additional control in the shift of the compensation voltage for separating various compounds. Since DMS separations are based upon the difference in mobility in high and low fields, it is difficult to predict a priori what modifier concentration will provide the best separations. Having access to a wide range of possible concentrations expands the potential separation power in DMS, FAIMS, or IMS. Moreover, in various embodiments, the additional control on the lower concentration range of the liquid modifier delivered to the curtain chamber can also help achieve a higher sensitivity for the detection of compounds that undergo electron or proton transfer reactions with the modifier.

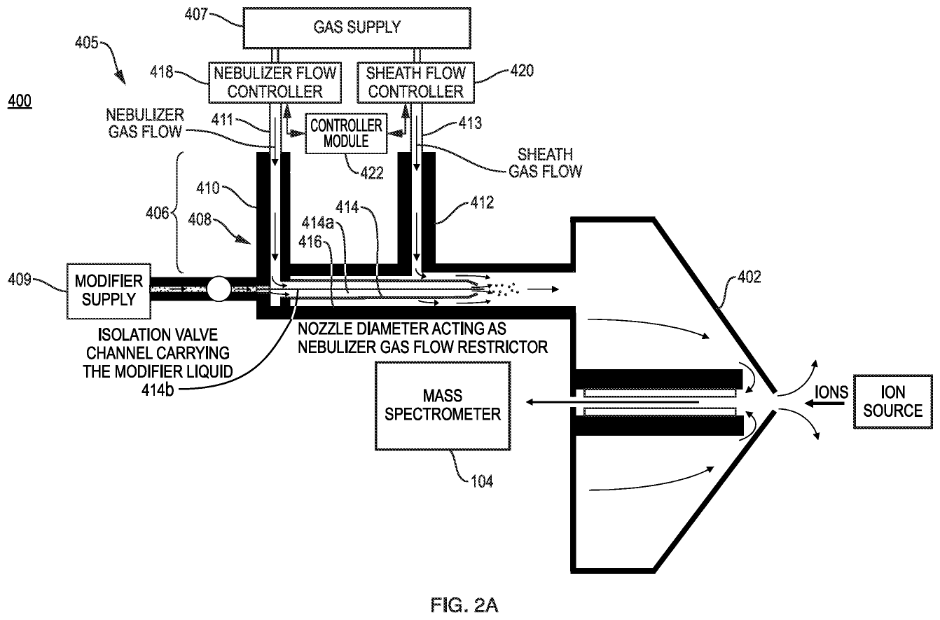

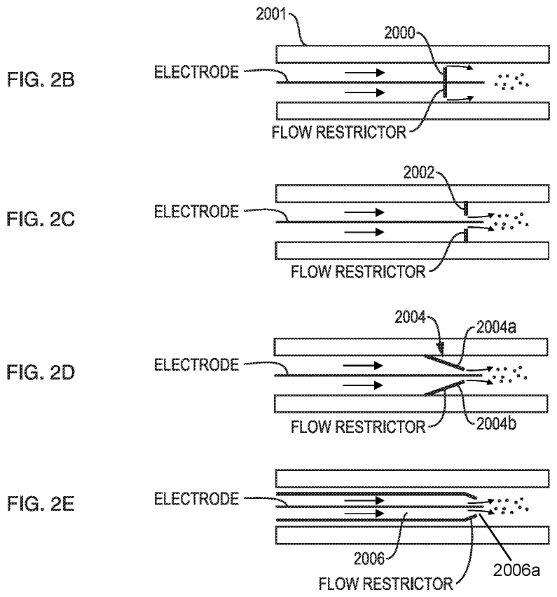

FIG. 2A schematically depicts a mass spectrometer system 400 according to another embodiment of the present teachings that includes a DMS 402 and a mass spectrometer 104, which operate in a similar manner as that disclosed above with respect to the previous embodiment. The mass spectrometer system 400 includes a system 405 according to another embodiment of the present teachings for delivery of a curtain gas in which a liquid modifier is entrained to the curtain chamber of the DMS. More specifically, the mass spectrometer system 400 includes a fluid manifold 406 (which is herein also referred to as a gas distribution system) that provides a fluid interface between a gas supply 407 and a modifier supply 409. The fluid manifold 406 includes a frame 408 defining two gas conduits 410/412, where the gas conduit 410 is in fluid communication with a nebulizer 414, which is positioned in a conduit 416 provided by the frame 408. The nebulizer is in fluid communication with the modifier supply 409 in a manner similar to that described above in connection with the nebulizer 414.

In this embodiment, the gas supply 407, e.g., a source of nitrogen gas, supplies a gas to both conduits 410 and 412 via delivery gas conduits 411 and 413. The gas delivered to the gas conduit 412 exits a distal end of that conduit to be introduced as a sheath flow gas into the conduit 416 in the vicinity of the nebulizer's nozzle to entrain the liquid droplets generated by the nebulizer and transport those liquid droplets to the curtain chamber of the DMS. The gas introduced into the conduit 410 exits through a distal opening of that conduit, which is in fluid communication with a nebulizer gas channel 414a of the nebulizer and flows through that channel to exit through the aperture of the nebulizer's nozzle and facilitate the formation of the liquid droplets. The nebulizer 414 further includes an electrode 414b that provides a channel for receiving the liquid modifier at a proximal end thereof and supplying the liquid modifier to a region in proximity of the nebulizer's nozzle.

In this embodiment, a nebulizer flow controller 418 is in fluid communication with the gas supply 407 and with the gas conduit 410 and controls the flow rate of the gas delivered to the gas conduit 410. Further, a sheath flow controller 420 is in fluid communication with the gas supply 407 and with the conduit 412 and controls the flow rate of the gas delivered to the conduit 412 The use of two independent flow controllers for controlling the gas flow into the conduits 410 and 412 advantageously allows adjusting the two flow rates, i.e., the flow rate of the gas into the conduits 410 and 412, independently. For example, the controllers can be utilized to provide the nebulizer gas and the sheath flow gas at different flow rates to the respective conduits. By way of illustration, in some embodiments, the flow rate of the gas delivered as the sheath flow gas can be in a range of about 0 to about 30 slpm and the flow rate of the gas delivered as the nebulizer gas can be in a range of about 0.1 to about 20 slpm, all by way of example.

A variety of flow controllers can be used as the flow controllers 418 and 420. By way of example, flow controllers that operate based on a pressure difference across an orifice or based on the heat dissipation rate caused by the flow can be utilized. Such flow controllers can be obtained from commercial sources or can be custom-made based on known techniques as informed by the present teachings.

In use, a stand-alone controller module 422 or a controller of the mass spectrometer (such as the controller 142 depicted in FIG. 1B), or a computer that is in communication with the mass spectrometer can calculate the required flow rates for the nebulizer gas and the sheath flow gas, e.g., based on a user defined flow rate for the curtain gas that is delivered to the DMS curtain chamber. The sum of the nebulizer gas flow rate and the sheath gas flow rate equals the curtain gas flow rate, and the ratio of the nebulizer gas flow rate and the sheath gas flow rate can be predetermined and automatically adjusted based on the target flow rate for the curtain gas flow. The calculated values for the nebulizer gas flow rate and the sheath gas flow rate can then be transmitted to the flow controllers 418 and 420 so as to set the flow rates of the nebulizer gas and the sheath flow gas.

In some embodiments, a flow restrictor can be positioned in the gas-delivery channel of the nebulizer to adjust the flow rate of the nebulizing gas that exits the nebulizer's aperture. Such restrictions can create a high velocity gas flow at the nebulizer's aperture to facilitate the formation of liquid droplets. By way of example, FIGS. 2A, 2B, 2C, 2D, and 2E schematically depict examples of such flow restrictors that can be employed in various embodiments of the present teachings. FIG. 2B shows a flow restrictor 2000 in the form of a disk that is positioned within the gas-delivery channel of a nebulizer 2001 to restrict the flow of the nebulizing gas to an annulus formed between the outer periphery of the disk and an inner surface of the gas-delivery channel. FIG. 2C shows another flow restrictor 2002 that is in the form of a disk having a central opening that allows the passage of the nebulizing gas therethrough. The solid peripheral portion of the disk forces the nebulizing gas to flow through the central opening, which is smaller than the inner diameter of the gas-delivery channel, thereby increasing the flow speed of the gas. FIG. 2D schematically depicts another flow restrictor 2004 that includes slanted surfaces 2004a/2004b providing an opening, where the slanted surfaces direct the gas into the central opening. FIG. 2E schematically depicts a flow restrictor 2006 that is similar to that shown in FIG. 1B, where the flow restrictor provides an enclosure for the nebulizer's electrode that provides an aperture 2006a at its distal end through which the nebulizing gas can flow.

The following examples are provided for elucidation of various aspects of the present teachings and are not provided to necessarily indicate optimal ways of practicing the present teachings and/or optimal results that can be obtained.

### EXAMPLES

In the following examples, a prototype triple quadrupole mass spectrometer having a DMS interface was utilized to obtain the data. In the following examples, samples were infused using a built-in syringe pump of the instrument and the modifier delivery system was controlled independently of the instrument. Further, in the following examples, nitrogen was used as the curtain gas.

### Example 1

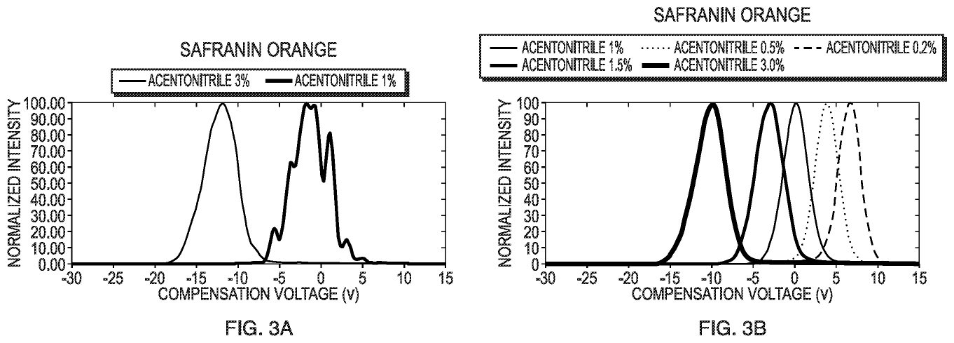

FIG. 3A shows the normalized intensity of Safranin Orange ions as a function of compensation voltage applied to the electrodes of the DMS using Acetonitrile as the liquid modifier. The data presented in FIG. 3A were obtained using a conventional system, such as that depicted in FIG. 1A, for the introduction of the Acetonitrile entrained in a curtain gas flow into the curtain chamber of the DMS at two different modifier concentrations in the curtain gas. The trace on the left shows the normalized ion intensity for a modifier liquid flow rate of 1200 μl/min that resulted in an Acetonitrile concentration of 3% in the gas delivered to the curtain chamber and the trace on the right shows the normalized ion intensity for a lower modifier liquid flow rate of 400 μl/min that resulted in an Acetonitrile concentration of 1%. The trace on the right shows that in this example, at the lower modifier flow rate, the ion signal exhibited fluctuations, which were absent from the respective ion signal acquired at the higher modifier flow rate, and hence at the higher concentration of the Acetonitrile. The fluctuations represent general system instability that occurs, e.g., due to inhomogeneity of the modifier/curtain gas mixture.

By way of comparison, FIG. 3B shows similar ion intensity data obtained for Safranin Orange ions using a system according to an embodiment, such as the system depicted in FIG. 1B for delivery of Acetonitrile as the liquid modifier to the curtain chamber of the DMS at different flow rates, and hence different resultant concentrations of the Acetonitrile in the curtain chamber. FIG. 3B shows that the use of a system according to the present teachings allows maintaining signal stability over a range of modifier concentrations from 0.2% to 3%. There was no indication of signal fluctuations across this range.

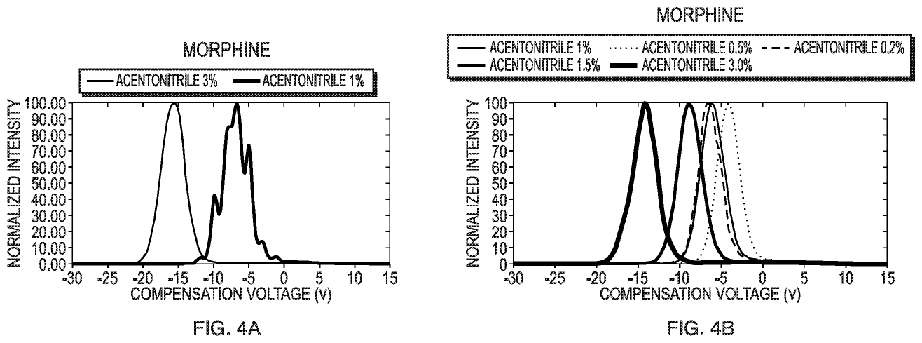

FIG. 4A shows normalized ion intensity data obtained for Morphine ions as a function of the compensation voltage applied to the DMS using a conventional system for the delivery of the liquid modifier and FIG. 4B shows the respective data obtained using a system similar to that shown in FIG. 1B. Again, the data shows that the use of a system according to the present teachings allowed acquisition of stable ion intensity data even at very low concentrations of the liquid modifier.

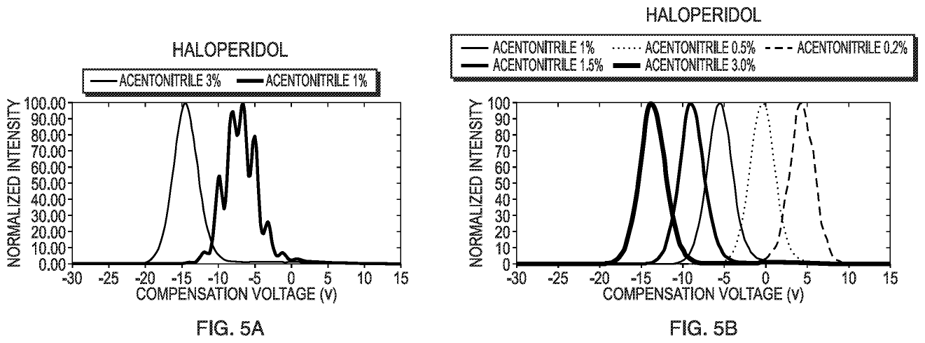

FIGS. 5A and 5B show, respectively, normalized ion intensity data obtained for Haloperidol ions using Acetonitrile as the liquid modifier and using a conventional system and a system according to the present teachings, respectively, for the delivery of the Acetonitrile via a curtain gas to the curtain chamber of the DMS. Again, the data shows that the use of a system according to the present teachings resulted in acquisition of stable ion signals even at very low concentrations of the liquid modifier.

### Example 2

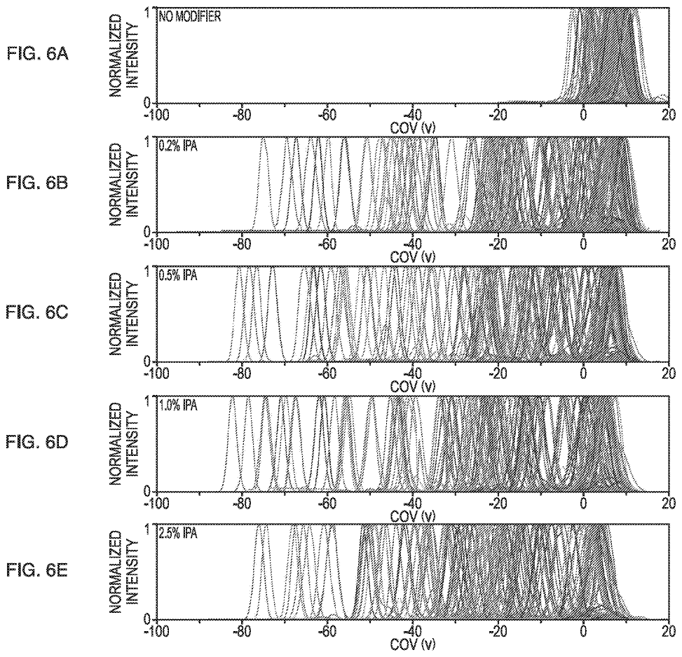

FIGS. 6A, 6B, 6C, 6D, and 6E show normalized ion intensity data for a 140 compound mixture acquired, respectively, without a liquid modifier (FIG. 6A) and with Isopropyl Alcohol (IPA) as the liquid modifier delivered to the curtain chamber of the DMS using a delivery system according to an embodiment of the present teachings, such as the system depicted in FIG. 1B, at different concentrations (i.e., V/V % ratios of 0.2% (6B), 0.5% (6C), 1.0% (6D), and 2.5% (6E)).

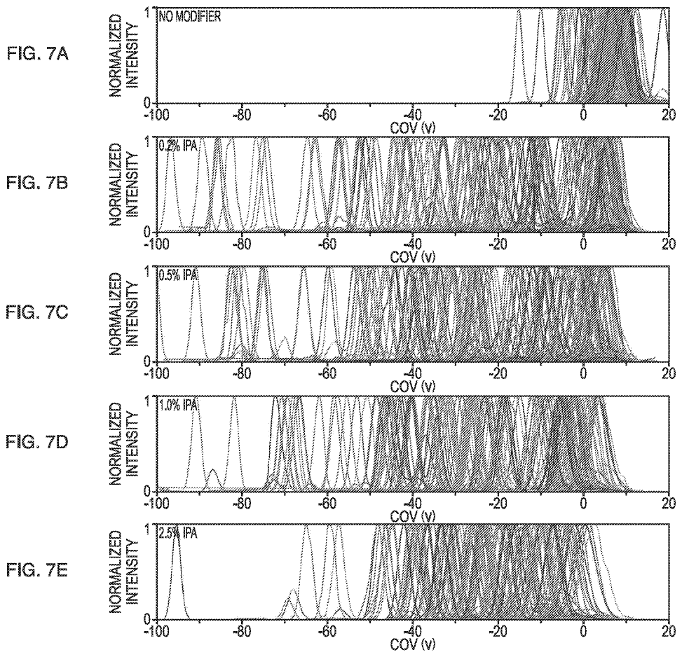

By way of further illustration, FIGS. 7A, 7B, 7C, 7D, and 7E show normalized ion intensity data for the same sample acquired, respectively, without a liquid modifier (FIG. 7A) and with Ethyl Acetate as the liquid modifier delivered to the curtain chamber of the DMS using the system employed for obtaining the IPA data and at V/V ratios of Ethyl Acetate comprising 0.2% (FIGS. 7B), 0.5% (FIGS. 7C), 1.0% (FIG. 7D), and 2.5% (FIG. 7E).

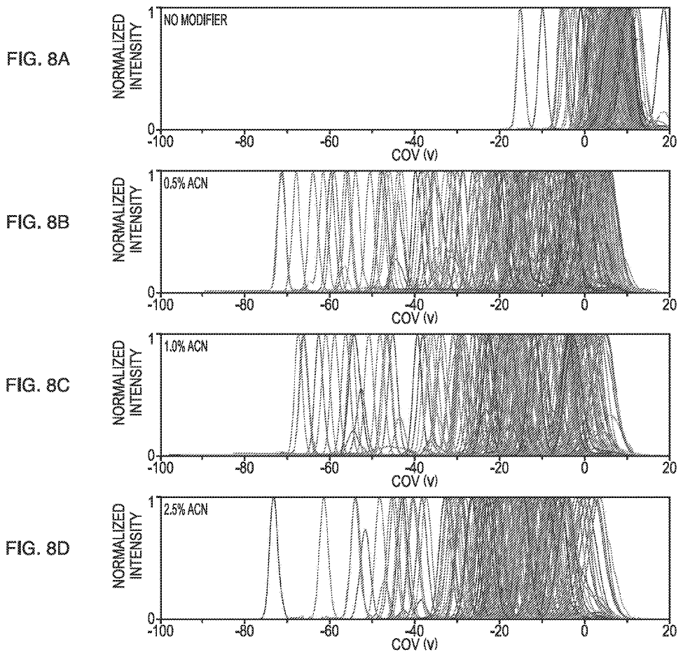

Further, FIGS. 8A, 8B, 8C, and 8D show normalized ion intensity data for the same sample acquired, respectively, without a liquid modifier (FIG. 8A) and with Acetonitrile as the liquid modifier delivered to the curtain chamber of the DMS using the same system according to the present teachings at different V/V ratios of Acetonitrile comprising 0.5% (FIGS. 8B), 1.0% (FIG. 8C), and 2.5% (FIG. 8D).

The above data shows that the use of a system according to the present teachings for the delivery of the liquid modifier via a curtain gas to the curtain chamber of a DMS resulted in gas composition homogeneity and hence signal stability over a large concentration range of the liquid modifier and for a variety of different compounds and liquid modifiers.

As used herein the term “and/or” includes any and all combinations of one or more of the associated listed items and may be abbreviated as “/”. Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

While various embodiments have been illustrated and described in detail in the drawings and foregoing description, such illustration and description are to be considered illustrative or exemplary and not restrictive; embodiments of the present disclosure are not limited to the disclosed embodiments. Other variations to the disclosed embodiments can be understood and effected by those skilled in the art in practicing embodiments of the present disclosure, from a study of the drawings, the disclosure, and the appended claims.

In the claims, the word “comprising” does not exclude other elements or steps, and the indefinite article “a” or “an” does not exclude a plurality. A single processor or other processing unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

Those having ordinary skill in the art will appreciate that various changes can be made to the above embodiments without departing from the scope of the present teachings.

1. A mass spectrometer, comprising:
an ion mobility spectrometer (IMS) for receiving ions from an ion source,
a gas supply for providing a gas,
a modifier supply for providing a liquid modifier,
a nebulizer for receiving the liquid modifier from the modifier supply and generating liquid droplets for delivery to a curtain chamber of the IMS, and
a gas distribution system comprising a first gas-delivery conduit in fluid communication with the gas supply and with the nebulizer for delivery of at least a portion of the gas supplied by the gas supply to a region in vicinity of a nozzle of said nebulizer as a sheath flow gas and a second gas-delivery conduit in fluid communication with the gas supply and the nebulizer for delivery of at least a portion of the gas supplied by the gas supply to the nebulizer as nebulizer gas such that a combination of gas exiting the nozzle and the sheath flow gas flows as a curtain gas entraining the liquid droplets to the curtain chamber of the IMS.

2. The mass spectrometer of claim 1, further comprising at least one controller in fluid communication with said gas supply and with at least one of said first and second gas-delivery conduits for adjusting a flow rate of gas supplied to said at least one of said first and second gas-delivery conduits.

3. The mass spectrometer of claim 2, wherein said at least one controller comprises two independent controllers, wherein one of the two independent controllers is in fluid communication with the gas supply and with the first gas-delivery conduit for adjusting a flow rate of the sheath flow gas and the other one of the two independent controllers is in fluid communication with the gas supply and with the second gas-delivery conduit for adjusting a flow rate of the nebulizer gas.

4. The mass spectrometer of claim 1, wherein said gas distribution system comprises a fluid manifold providing said first and said second gas-delivery conduits such that one of said first and second gas-delivery conduits is in fluid communication with the gas supply via the other one of the first and second gas-delivery conduits.

5. The mass spectrometer of claim 4, wherein said first gas-delivery conduit comprises an inlet for receiving the gas from the gas supply and delivering a first portion of the received gas as the sheath flow gas to the vicinity of the nozzle and wherein said second gas-delivery conduit comprises an inlet in fluid communication with the first gas-delivery conduit for receiving a second portion of the gas received by the first gas-delivery conduit and delivering said second portion of the gas via an outlet thereof as the nebulizer gas to the nebulizer.

6. The mass spectrometer of claim 1, wherein said nebulizer comprises an electrode extending from a proximal inlet, which is configured for receiving the liquid modifier, to a distal outlet through which the liquid modifier and the nebulizer gas exit the nebulizer such that the liquid droplets of the liquid modifier are formed external to the electrode and in said vicinity of the nozzle.

7. The mass spectrometer of claim 6, wherein said nozzle has a nozzle aperture having an inner diameter in a range of about 100 micrometers to about 2 mm, and said electrode has an inner diameter in a range of about 50 micrometers to about 500 micrometers, and optionally in a range of about 50 micrometers to about 150 micrometers, and the distal outlet of the electrode protrudes through the nozzle aperture by a distance in a range of about 100 micrometers to about 4 mm.

8. A mass spectrometer, comprising:
an ion mobility spectrometer (IMS) for receiving ions from an ion source,
a gas supply for providing a gas,
a modifier supply for providing a liquid modifier,
a nebulizer for receiving the liquid modifier from the modifier supply and generating liquid droplets for delivery to a curtain chamber of the IMS, and
a fluid manifold configured to receive the liquid modifier from the modifier supply and deliver the liquid modifier to the nebulizer, said fluid manifold further being configured to receive the gas from the gas supply and provide a first portion of the gas as a sheath flow gas to a region in vicinity of a nozzle of the nebulizer and provide a second portion of the gas as a nebulizing gas to the nebulizer such that a combination of the sheath flow gas and gas exiting the nebulizer flows as a curtain gas entraining the liquid droplets to the curtain chamber of the IMS.

9. The mass spectrometer of claim 8, wherein the nebulizer comprises an electrode extending from a proximal inlet for receiving the liquid modifier to a distal outlet through which the liquid modifier exits the electrode such that liquid droplets are formed in the vicinity of the nozzle.

10. The mass spectrometer of claim 9, wherein an aperture of the nozzle has an inner diameter in a range of about 100 micrometers to about 2 mm, and optionally in a range of about 50 micrometers to about 500 micrometers, and optionally in a range of about 50 micrometers to about 150 micrometers, and the electrode has an inner diameter in a range of about 50 micrometers to about 500 micrometers, and optionally in a range of about 50 micrometers to about 150 micrometers, and the distal outlet of the electrode protrudes through the aperture of the nozzle by a distance in a range of about 100 micrometers to about 4 mm.

11. The mass spectrometer of claim 9, wherein said electrode is configured for application of a voltage thereto.

12. The mass spectrometer of any claim 9, wherein said fluid manifold comprises a liquid conduit having an inlet in fluid communication with said modifier supply for receiving said liquid modifier and having an outlet in fluid communication with said proximal inlet for delivering said liquid modifier to the nebulizer.

13. The mass spectrometer of claim 12, further comprising an isolation valve operably coupled to the liquid conduit of the fluid manifold for regulating liquid flow through the liquid conduit.

14. The mass spectrometer of claim 12, wherein said fluid manifold further comprises a first gas conduit extending from a proximal end providing an inlet for receiving the gas from the gas supply to a distal end providing an outlet through which the first portion of the gas exits the first gas conduit to provide said sheath flow gas in vicinity of the nozzle.

15. The mass spectrometer of claim 14, further comprising a second gas conduit having an inlet in fluid communication with said first gas conduit at a fluid junction so as to receive said second portion of the gas, said second gas conduit having an outlet in fluid communication with said nebulizer for delivering said second portion of the gas to the nebulizer as the nebulizing gas.

16. The mass spectrometer of claim 15, further comprising a flow restrictor positioned in said first gas conduit for adjusting a flow rate of said first portion of the gas provided as the sheath flow gas to the region in the vicinity of the nozzle of the nebulizer, and wherein optionally said flow restrictor is configured to generate a sufficient back pressure in said first gas conduit to allow flow of the second portion of the gas received by the first gas conduit to the nebulizer via the second gas conduit.

17. The mass spectrometer of claim 16, wherein said flow restrictor and a size of the aperture of the nozzle are configured to provide a desired gas flow rate of the nebulizing gas through the nebulizer, wherein optionally said desired gas flow rate for the nebulizing gas is in a range of about 0.1 slpm to about 20 slpm.

18. The mass spectrometer of claim 16, wherein said flow restrictor is configured to provide a flow rate in a range of about 0 slpm to about 30 slpm for said sheath flow gas.

19. The mass spectrometer of claim 16, wherein said flow restrictor comprises a disk with a disk aperture having a cross-sectional area less than a cross-sectional area of said first gas conduit, wherein a portion of the gas passing through said disk aperture forms said first portion of the gas that flows to the region in vicinity of the nozzle of the nebulizer, and wherein optionally said flow restrictor is adjustable so as to provide a plurality of flow rates for any of the sheath flow gas and the nebulizing gas.

20. The mass spectrometer of claim 9, further comprising a DC voltage supply for applying a DC voltage to said electrode and a controller for controlling operation of said DC voltage supply.
